(19) United States
(12) Patent Application Publication
(10) Pub. No.: US 2002/0026424 A1
(43) Pub. Date: Feb. 28, 2002

(54) License issuing device/method and contents reproducing device/method

(75) Inventor: Teruo Akashi, Osaka (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 09/942,594

(22) Filed: Aug. 31, 2001

(30) Foreign Application Priority Data
Aug. 31, 2000 (JP) 2000-262912

(51) Int. Cl. G06F 17/60

(52) U.S. Cl. 705/57

(57) ABSTRACT

A license issuing device encrypts license information of contents desired by a user with device ID of a memory card carried by the user, and writes the encrypted license information in the memory card. A contents reproducing device decrypts the license information written in the memory card carried by the user with the device ID of the memory card. The contents reproducing device decrypts encrypted contents corresponding to the contents of which use is permitted in the decrypted license information and reproduces the decrypted contents.

### BACKGROUND OF THE INVENTION

The present invention relates to a license issuing device, a contents reproducing device, a license issuing method, and a contents reproducing method. More particularly, the present invention relates to a license issuing device, a contents reproducing device, a license issuing method, and a contents reproducing method in a contents providing system that provides contents and a license for the contents separately.

With the advance of digital technology, not only software programs but also productions such as pictures, music, and films are now managed and distributed as digital data. Further, in recent years, with remarkable progress of network technology, an environment enabling distribution of these productions to users via a network at any time and any place is about to be established.

These contents as digital data do not deteriorate in quality by repeated replication. Therefore, providers of these contents are absolutely required to take measures for blocking unauthorized use of distributed contents such as duplication without permission of the copyright holder. In this regard, development in cryptographic technology contributes to improvement in the security level of the contents. As encryption schemes, known are DES as one type of symmetric encryption in which the same key is used for encryption and decryption, and RSA encryption as asymmetric encryption in which different keys are used for encryption and decryption.

As the first example of technology for preventing unauthorized use of contents, a selling scheme as follows is known. All or part of contents intended to be put on the market are encrypted in advance so that the contents are protected from being used in the state as they are. A user purchases a license for releasing the encrypted state. In this scheme, ID unique to a device for reproducing the contents is recognized, and a license issued is encrypted including this ID. During reproduction, the ID retrieved by decrypting the license is compared with the ID unique to the reproducing device. Only when the two IDs match with each other, reproduction is performed. In this way, by limiting the device permitted to reproduce the contents, use of the contents by a device illegally duplicated is prevented.

As the second example, there is known a technique where an administration center is established on a network. During reproduction of contents, a user who has already registered his or her name accesses the administration center via the network, and the administration center verifies the user by a password or the like.

In the first example, once the user purchases the contents with the license, the user can reproduce the contents only with the licensed reproducing device. Therefore, although the contents are freely distributed, the reproducing device that can reproduce the contents is limited. In other words, the following problems arise. A program for which the license has been given in connection with a specific computer can only be used by accessing the specific computer. A piece of music for which the license has been given in connection with a home stationary player cannot be used with a portable terminal. A film for which the license has been given in connection with a portable video reproducing device can not be reproduced with a unit equipped with a home large screen display.

In the second example, a means for connecting to a network and communicating with the administration center is inevitably required. Therefore, use of contents with a reproducing device unequipped with such a function is limited.

### SUMMARY OF THE INVENTION

According to one aspect of the present invention, the license issuing device writes license information permitting use of contents in a portable license storing device. The license storing device has uniquely identifiable device ID and a function of verifying the validity of a partner device. The license issuing device includes a verification means, a license information production means, and a first encryption means. The verification means verifies the validity of a license storing device carried by a user. The license information production means produces license information permitting use of contents designated by the user when the license storing device carried by the user is verified as valid by the verification means. The first encryption means encrypts the license information produced by the license information production means with the device ID of the license storing device carried by the user and writes the encrypted license information in the license storing device carried by the user.

In the above license issuing device, license information of contents desired by a user is written in the license storing device as a portable individual hardware unit. Therefore, the user, who carries the license storing device in which the license information of the desired contents has been written, can receive the contents using any of contents reproducing devices in various forms compatible with the license storing device.

The license information is encrypted with the device ID of the license storing device. This makes it possible to prevent fraud such as attempting to receive contents using a license storing device in which encrypted license information has been illegally duplicated.

The license issuing device writes only the license information of the contents in the license storing device carried by the user. Therefore, even when the contents desired by the user is large in capacity, the time required for issuance of the license information does not increase. Also, there is no need to worry about the memory capacity of the license storing device.

Moreover, since the data amount of the license information is small compared with the data amount of the contents, the user can obtain a large number of contents with one license storing device.

Preferably, the license information includes contents ID for identifying the contents designated by the user.

Preferably, the license information includes a contents use condition representing a restriction during use of the contents designated by the user.

Preferably, the license information includes a decryption key for decrypting the contents designated by the user.

Preferably, the verification means includes a second encryption means. The second encryption means encrypts the device ID of the license storing device carried by the user with a device key possessed by the license storing device carried by the user. And, the first encryption means encrypts the license information with the device ID encrypted by the second encryption means and writes the encrypted license information in the license storing device carried by the user.

Preferably, the license issuing device is connected to the license storing device carried by the user via a network.

In the above license issuing device, the user can receive license information issued by the license issuing device through a portable terminal accessible to the license issuing device via a network even when the user is away from the position of the license issuing device.

According to another aspect of the present invention, the contents reproducing device decrypts encrypted contents and reproduces the decrypted contents. The contents reproducing device decrypts contents based on license information encrypted with device ID of a portable license storing device and stored in the license storing device, and reproduces the decrypted contents. The license storing device has a uniquely identifiable device ID and a function of verifying the validity of a partner device. The contents reproducing device includes a verification means, a decryption means, and a reproduction means. The verification means verifies the validity of a license storing device carried by a user. The decryption means decrypts license information stored in the license storing device carried by the user with the device ID of the license storing device when the license storing device carried by the user is verified as valid by the verification means. The reproduction means decrypts encrypted contents corresponding to contents of which use is permitted in the license information obtained by the decryption means and reproduces the decrypted contents.

In the above contents reproducing device, the encrypted contents are decrypted using the license information written in the license storing device carried by the user and reproduced. Therefore, the user, who carries the license storing device in which the license information of the contents desired has been written, can receive the contents using any of contents reproducing devices in various forms compatible with the license storing device.

The license information written in the license storing device carried by the user is decrypted with the device ID of the license storing device. This makes it possible to prevent fraud such as attempting to receive contents using a license storing device in which encrypted license information has been illegally duplicated.

Preferably, the license information stored in the license storing device carried by the user includes a decryption key for decrypting the contents of which use is permitted in the license information, and the reproduction means decrypts the encrypted contents corresponding to the contents of which use is permitted in the license information with the decryption key included in the license information obtained by the decryption means.

Preferably, the license information stored in the license storing device carried by the user includes contents ID for identifying the contents of which use is permitted in the license information, and the reproduction means acquires the encrypted contents corresponding to the contents of which use is permitted in the license information using the contents ID included in the license information obtained by the decryption means.

Preferably, the contents reproducing device further includes an accumulation means for accumulating encrypted contents, and the reproduction means acquires the encrypted contents corresponding to the contents of which use is permitted in the license information obtained by the decryption means from the accumulation means.

In the above contents reproducing device, all of contents the user wish to reproduce can be accumulated in the accumulation means. This makes it possible to promptly reproduce contents having a large capacity that otherwise take time to be acquired.

Preferably, the reproduction means acquires the encrypted contents corresponding to the contents of which use is permitted in the license information obtained by the decryption means via a network.

In the above contents reproducing device, contents are acquired on an as-needed basis during reproduction of the contents. This virtually provides an effect similar to that obtained when the user owns a contents server having an infinite capacity.

Preferably, the license information stored in the license storing device carried by the user includes a contents use condition representing a restriction during use of the contents of which use is permitted in the license information, and the reproduction means decrypts the encrypted contents corresponding to the contents of which use is permitted in the license information according to the contents use condition included in the license information obtained by the decryption means and reproduces the decrypted contents.

Preferably, the contents reproducing device further includes: a contents use condition updating means, an updated license information production means, an encryption means, and an overwriting means. The contents use condition updating means updates a contents use condition included in the license information obtained by the decryption means after the reproduction of the contents by the reproduction means. The updated license information production means produces updated license information including the contents use condition updated by the contents use condition updating means replacing the contents use condition included in the replacing the contents use condition included in the license information obtained by the decryption means. The encryption means encrypts the updated license information produced by the updated license information production means with the device ID of the license storing device carried by the user. The overwriting means overwrites the license information stored in the license storing device carried by the user with the updated license information encrypted by the encryption means.

The above contents reproducing device can update the contents use condition when the contents use condition changes after reproduction of the contents, and thus retain the correct contents use condition.

According to yet another aspect of the present invention, the contents reproducing device decrypts encrypted contents and reproduces the decrypted contents. The contents reproducing device decrypts contents based on license information encrypted with device ID of a portable license storing device encrypted with a device key of the license storing device and stored in the license storing device, and reproduces the decrypted contents. The license storing device has a uniquely identifiable device ID and a function of verifying the validity of a partner device. The contents reproducing device includes a verification means, a decryption means, and a reproduction means. The verification means verifies the validity of a license storing device carried by a user, and, when the license storing device is verified valid, encrypts the device ID of the license storing device with the device key of the license storing device to produce the encrypted device ID. The decryption means decrypts the license information stored in the license storing means carried by the user with the encrypted device ID produced by the verification means. The reproduction means decrypts encrypted contents corresponding to contents of which use is permitted in the license information obtained by the decryption means and reproduces the decrypted contents.

According to yet another aspect of the present invention, the license issuing method writes license information permitting use of contents in a portable license storing device. The license storing device has uniquely identifiable device ID and a function of verifying the validity of a partner device. The license issuing method includes a verifying step and a writing step. In the verifying step, the validity of a license storing device carried by a user is verified. In the writing step, when the license storing device carried by the user is verified as valid, license information permitting use of contents designated by the user is encrypted with device ID of the license storing device carried by the user, and the encrypted license information is written in the license storing device carried by the user.

In the above license issuing method, license information of contents desired by the user is written in the license storing device as a portable individual hardware unit.

Therefore, the user, who carries the license storing device in which the license information of the desired contents has been written, can receive the contents using contents reproducing devices in various forms.

The license information is encrypted with the device ID of the license storing device. This makes it possible to prevent fraud such as attempting to receive contents using a license storing device in which encrypted license information has been illegally duplicated.

In the above license issuing method, only the license information of the contents is written in the license storing device carried by the user. Therefore, even when the contents desired by the user is large in capacity, the time required for issuance of the license information does not increase. Also, there is no need to worry about the memory capacity of the license storing device.

Moreover, since the data amount of the license information is small compared with the data amount of the contents, the user can obtain a large number of contents with one license storing device.

According to yet another aspect of the present invention, the contents reproducing method decrypts encrypted contents and reproduces the decrypted contents. The contents reproducing method decrypts contents based on license information encrypted with device ID of a portable license storing device and stored in the license storing device. The license storing device has a uniquely identifiable device ID and a function of verifying the validity of a partner device. The contents reproducing method includes a verifying step, a decrypting step, and a reproducing step. In the verifying step, the validity of a license storing device carried by a user is verified. In the decrypting step, license information stored in the license storing device carried by the user is decrypted with the device ID of the license storing device when the license storing device carried by the user is verified as valid in the verifying step. In the reproducing step, encrypted contents corresponding to contents of which use is permitted in the license information obtained in the decrypting step is decrypted, and the decrypted contents are reproduced.

In the above contents reproducing method, the encrypted contents are decrypted using the license information written in the license storing device carried by the user and reproduced. Therefore, the user, who carries the license storing device in which the license information of the contents desired has been written, can receive the contents using contents reproducing devices in various forms.

The license information written in the license storing device carried by the user is decrypted with the device ID of the license storing device. This makes it possible to prevent fraud such as attempting to receive contents using a license storing device in which encrypted license information has been illegally duplicated.

Preferably, in the reproducing step, encrypted contents corresponding to contents of which use is permitted in the license information obtained in the decrypting step are acquired via a network.

In the above contents reproducing method, encrypted contents are acquired via a network on an as-needed basis during reproduction of the contents. This virtually provides an effect similar to that obtained when the user owns a contents server having an infinite capacity.

Preferably, the license information stored in the license storing device carried by the user includes a contents use condition representing a restriction during use of contents of which use is permitted in the license information, and in the reproducing step, encrypted contents corresponding to contents of which use is permitted in the license information are decrypted according to the contents use condition included in the license information obtained in the decrypting step, and the decrypted contents are reproduced.

Preferably, the contents reproducing method further includes an updating step, an encrypting step, and an overwriting step. In the updating step, a contents use condition included in the license information obtained in the decrypting step is updated after the reproduction of the contents in the reproducing step. In the encrypting step, updated license information including the contents use condition updated in the updating step replacing the contents use condition included in the license information obtained in the decrypting step is encrypted with the device ID of the license storing device carried by the user. In the overwriting step, the license information stored in the license storing device carried by the user is overwritten with the updated license information encrypted in the encrypting step.

In the above contents reproducing method, the contents use condition can be updated when it changes after reproduction of the contents, and thus the correct contents use condition can be retained.

### BRIEF DESCRIPTION OF THE DRAWINGS

FIG. 1 is an illustration of the construction of a contents providing system in Embodiment 1 of the present invention.

FIG. 2 is a block diagram showing specific constructions of a memory card and a license issuing device shown in FIG. 1.

FIG. 3 shows a data structure of a database where the contents title, the contents ID, and the contents decryption key are associated with one another.

FIG. 4 is a flowchart showing a procedure of issuance of license information by the license issuing device shown in FIG. 2.

FIG. 5 shows information stored in a license storing means of the memory card.

FIG. 6 is a flowchart showing a procedure of mutual verification between the memory card and the license issuing device.

FIG. 7 is a block diagram showing specific constructions of the memory card and a contents reproducing device shown in FIG. 1.

FIG. 8 is a flowchart showing a procedure of reproduction of contents by the contents reproducing device shown in FIG. 7.

FIG. 9 is a block diagram showing a construction of a contents reproducing device in Embodiment 2 of the present invention.

FIG. 10 illustrates an example of application of the contents providing system shown in FIG. 1.

### DESCRIPTION OF THE PREFERRED EMBODIMENTS

Hereinafter, preferred embodiments of the present invention will be described with reference to the accompanying drawings. The same or similar components are denoted by the same reference numerals, and the description thereof is not repeated. Note that the present invention does not impose any limitation on the cryptographic algorithm. However, in the following description of the embodiments, a common key encryption scheme using the same key for encryption and decryption is assumed as the cryptographic algorithm unless otherwise specified.

(Embodiment 1)

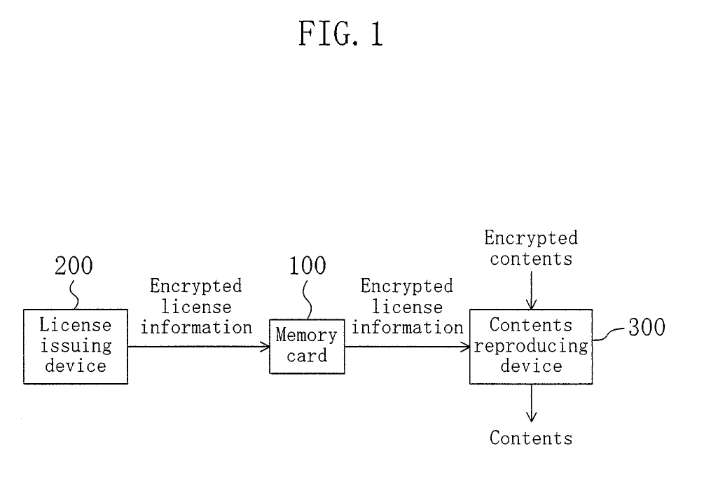

FIG. 1 illustrates a construction of a contents providing system in Embodiment 1 of the present invention. As shown in FIG. 1, the contents providing system distributes digital contents that are electronic productions such as software, music, and video (hereinafter, called merely “contents”) and license information permitting use of these contents separately. The contents are encrypted and distributed as encrypted contents so that they are unusable in the form as they are. The encrypted contents are distributed in various ways such as on a network, by broadcasting, and in a package.

A user who desires to receive contents inserts a memory card 100 into a license issuing device 200. The license issuing device 200 encrypts license information permitting use of the contents desired by the user with device ID of the memory card 100 carried by the user and writes the encrypted license information in the memory card 100. That is, only the encrypted license information is written in the memory card 100. The user then inserts the memory card 100 with the encrypted license information written therein into a contents reproducing device 300. The contents reproducing device 300 decrypts the license information written in the memory card 100 carried by the user with the device ID of the memory card 100. The contents reproducing device 300 then decrypts encrypted contents corresponding to the contents of which use is permitted in the decrypted license information, and reproduces the decrypted contents. In this way, contents and license information permitting use of the contents are provided.

Hereinafter, specific constructions of the memory card 100, the license issuing device 200, and the contents reproducing device 300 shown in FIG. 1 will be described in detail, together with a procedure of issuance of license information by the license issuing device 200 and a procedure of reproduction of contents by the contents reproducing device 300.

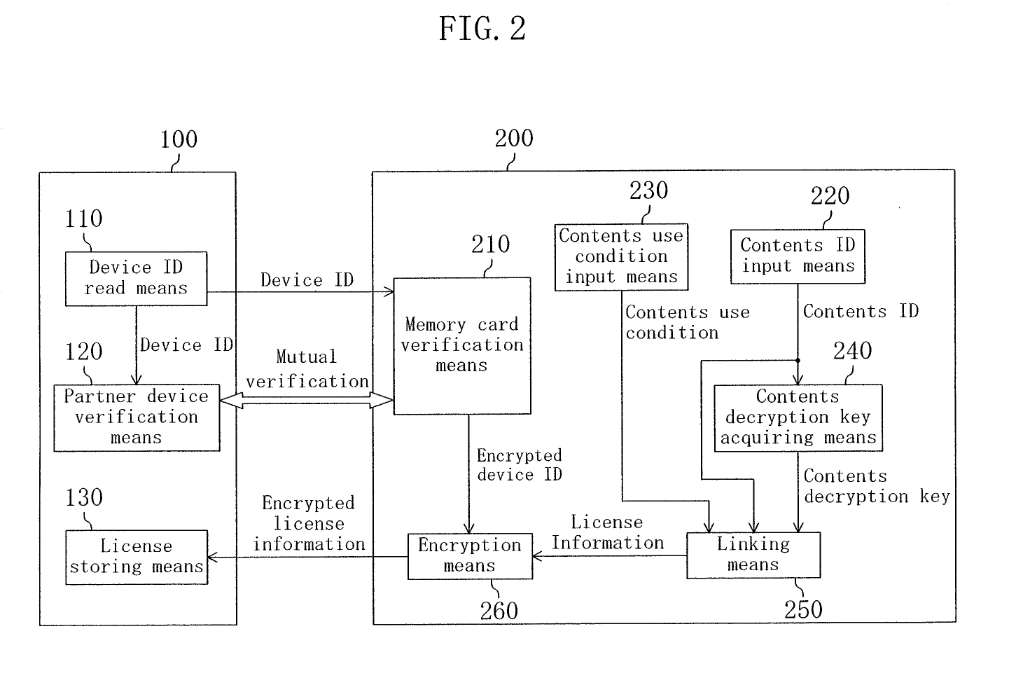

FIG. 2 is a block diagram showing specific constructions of the memory card 100 and the license issuing device 200 shown in FIG. 1.

<Construction of Memory Card 100>

The memory card 100 is a portable independent hardware unit having uniquely identifiable device ID. The memory card 100 includes a device ID read means 110, a partner device verification means 120, and a license storing means 130.

The device ID read means 110 reads and outputs the device ID of the memory card 100.

The partner device verification means 120 verifies whether or not a partner device to/from which license information is transmitted/received is a valid device. The partner device is the license issuing device 200 in the case of receiving license information from the license issuing device 200 and the contents reproducing device 300 in the case of receiving reproduction of contents from the contents reproducing device 300. The partner device verification means 120 is necessary to exclude a fraud license issuing device that attempts to issue unusable license information and get a license fee.

The license storing means 130 stores encrypted license information received from the license issuing device 200. A flash memory, for example, may be used as the license storing means 130.

<Construction of License Issuing Device 200>

The license issuing device 200 includes a memory card verification means 210, a contents ID input means 220, a contents use condition input means 230, a contents decryption key acquiring means 240, a linking means 250, and an encryption means 260.

The memory card verification means 210 verifies whether or not the memory card 100 is a valid one. Prior to verification, the memory card verification means 210 acquires the device ID from the memory card 100 and, after mutual verification with the memory card 100, encrypts the device ID and outputs the encrypted device ID. This is done to allow the contents reproducing device 300 to obtain the same key during reproduction of contents.

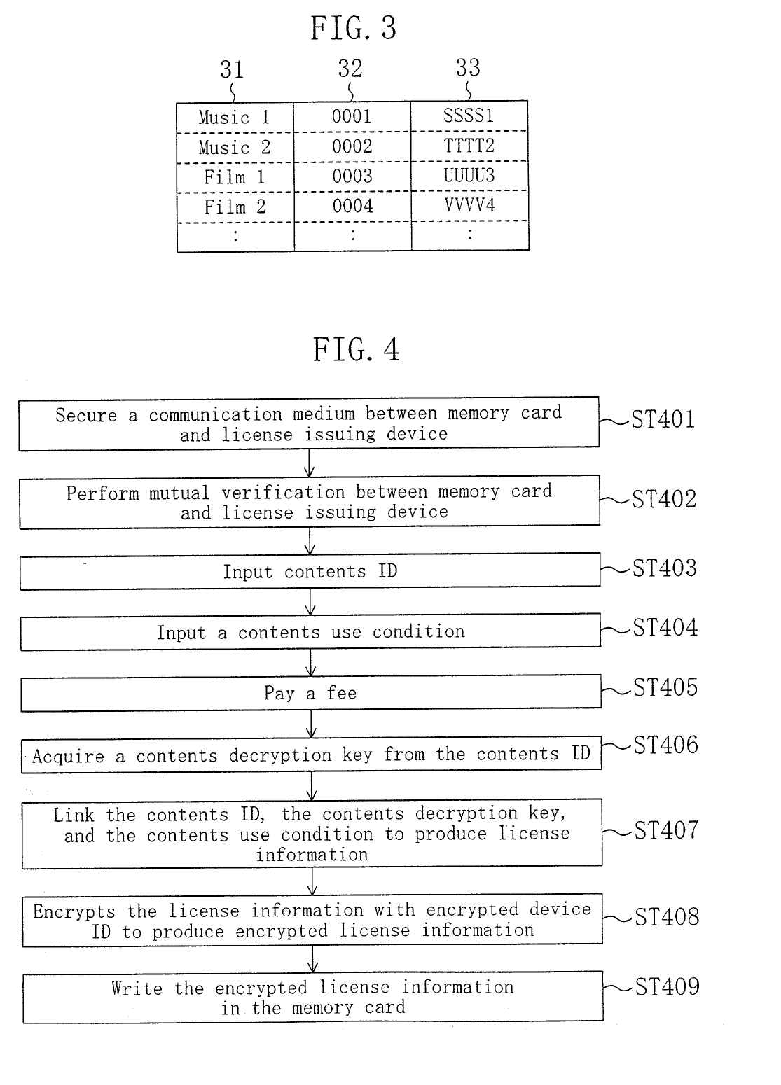

The contents ID input means 220 outputs contents ID of the contents designated by the user. The contents ID refers to a code for identifying the contents. As an example of the contents ID input means 220, usable is a means that directly prompts the user to input contents ID of desired contents via an input device such as a keyboard and a touch panel and outputs the input contents ID as it is. As another example, usable is a means that displays a list of contents titles available for issuance of license information and urges the user to select a desired one. Contents ID corresponding to the selected contents title is retrieved from a database as shown in FIG. 3 where the contents title 31 and the contents ID 32 are associated with each other. In the database shown in FIG. 3, the contents title 31, the contents ID 32, and the contents decryption key 33 are associated with one another. The information of the contents decryption key 33 is protected from retrieval from outside.

The contents use condition input means 230 outputs a contents use condition. The contents use condition refers to information indicating a restriction on the occasion of use of contents. For example, when the contents are a software program, the contents use condition may be information indicating a restriction that “the data amount handled is up to 100 K bytes”. In another example where the contents are music data, the contents use condition may be information indicating “the period during which reproduction is permitted”. There are various candidates of contents use conditions depending on the characteristics of the contents. Therefore, use condition databases may be provided for the respective contents or respective categories of contents. In this case, also, as in the contents ID input means 220 described above, a list of use conditions may be displayed to prompt the user to select from the list.

The contents decryption key acquiring means 240 receives the contents ID from the contents ID input means 220 and acquires a key for decrypting the encrypted contents corresponding to the contents ID. For example, the key may be acquired by referring to the database shown in FIG. 3.

The linking means 250 links the contents ID from the contents ID input means 220, the contents use condition from the contents use condition input means 230, and the contents decryption key from the contents decryption key acquiring means 240, to produce license information.

The encryption means 260 encrypts the license information produced by the linking means 250 with the encrypted device ID from the memory card verification means 210, to produce encrypted license information. The encryption means 260 writes the encrypted license information in the license storing means 130 of the memory card 100.

<Procedure of Issuance of License Information>

FIG. 4 is a flowchart showing a procedure of issuance of license information by the license issuing device 200 shown in FIG. 2. With reference to FIG. 4 together with FIG. 2, the procedure of issuance of license information will be described.

First, in step ST401, the user inserts the memory card 100 into an insertion slot of the license issuing device 200. By this insertion, a pin of the memory card 100 comes into electrical contact with a socket of the license issuing device 200, to thereby secure a communication medium for data transmission/reception between the memory card 100 and the license issuing device 200.

In step ST402, the memory card 100 and the license issuing device 200 mutually verify that they are valid devices to each other. This procedure of mutual verification will be described later in detail. If an error occurs during the mutual verification, the processing is discontinued, and the user is notified of this error. After the mutual verification, the memory card verification means 210 encrypts the device ID of the memory card 100 to produce encrypted device ID.

In step ST403, the user inputs contents ID corresponding to desired contents via the contents ID input means 220. In this way, the contents ID of the contents desired by the user is obtained.

In step ST404, the user inputs a contents use condition via the contents use condition input means 230. In this way, the contents use condition desired by the user is obtained.

In step ST405, the user pays a fee determined depending on the contents and the use condition desired by the user. A known means/method may be adopted for payment of the fee.

In step ST406, the contents decryption key acquiring means 240 acquires a key for decrypting the encrypted state of the contents corresponding to the contents ID obtained in step ST403. In this embodiment, the key is acquired by referring to the database shown in FIG. 3.

In step ST407, the linking means 250 links the contents ID obtained in step ST403, the contents use condition obtained in step ST404, and the contents decryption key obtained in step ST406, to produce license information.

In step ST408, the encryption means 260 encrypts the license information obtained in step ST407 with the encrypted device ID obtained in step ST402, to produce encrypted license information.

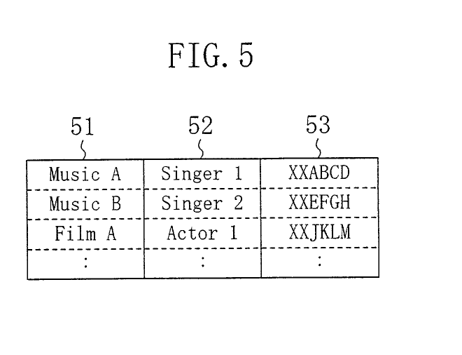

In step ST409, the encryption means 260 writes the encrypted license information obtained in step ST408 in the license storing means 130 of the memory card 100. In general, a plurality of units of encrypted license information for a plurality of contents are stored in the license storing means 130 of the memory card 100. For distinguishing one from another, therefore, as shown in FIG. 5, the contents title 51, the contents additional information 52, and the like are also written in association with the encrypted license information 53 in the license storing means 130. This facilitates the user to identify desired contents out of a plurality of units of encrypted license information at later use.

Thus, the license information for the contents desired by the user is written in the license storing means 130 of the memory card 100 carried by the user.

As described above, the license issuing device 200 in Embodiment 1, which is provided with the memory card verification means 210 and the encryption means 260, can store the license information separated from the contents in the memory card 100 that has been recognized as valid.

The contents proper desired by the user are not written, but only the license information for the contents is written in the memory card 100 carried by the user. Therefore, even when the contents desired by the user are large in capacity, the time required for issuance of the license information does not increase. Also, there is no need to worry about the memory capacity of the license storing means 130 of the memory card 100.

Moreover, since the data amount of the license information is small compared with the data amount of the contents, the user can obtain a large number of contents with one memory card 100.

In this embodiment, the license information produced by the linking means 250 includes the contents use condition. The contents use condition may not be used, and only the contents ID and the contents decryption key may be linked to produce license information. In this case, it is not necessary to provide the contents use condition input means 230.

Alternatively, the contents decryption key may not be used, and only the contents ID and the contents use condition may be linked to produce license information. In this case, it is not necessary to provide the contents decryption key acquiring means 240. Instead, however, the contents reproducing device 300 must be provided with a contents decryption key acquiring means.

<Procedure of Mutual Verification>

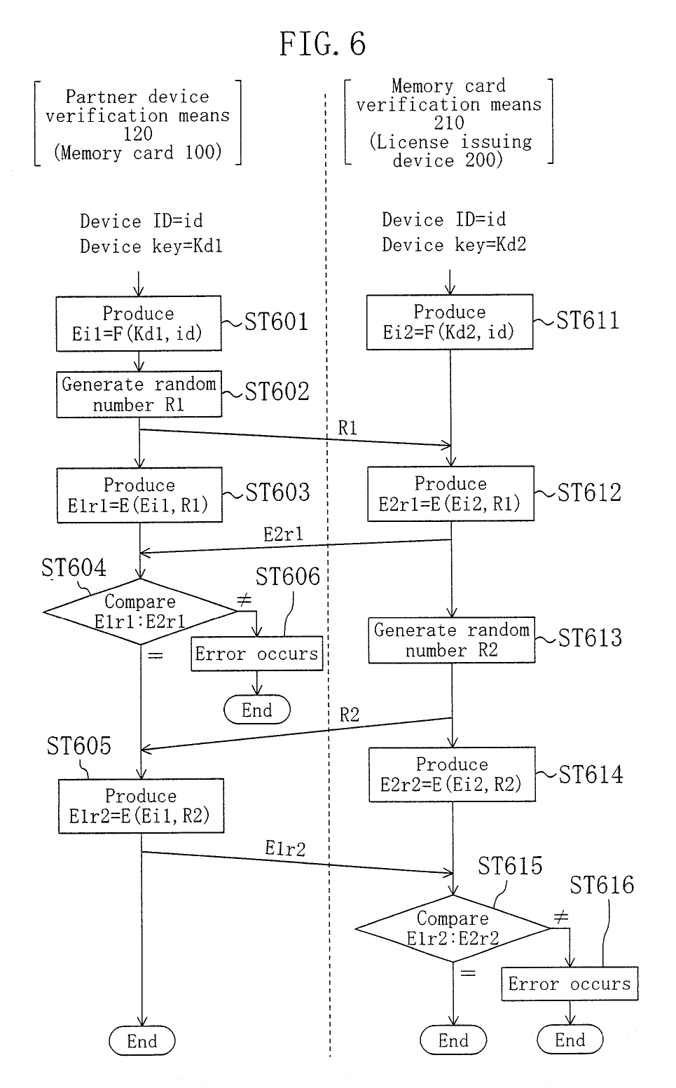

The procedure of mutual verification in step ST402 shown in FIG. 4 will be described with reference to FIG. 6 together with FIG. 2. Note that in FIG. 6, steps ST601 through ST606 represent processing of the partner device verification means 120 of the memory card 100, while steps ST611 through ST616 represent processing of the memory card verification means 210 of the license issuing device 200.

Prior to the verification, the memory card verification means 210 of the license issuing device 200 acquires the device ID (id) from the memory card 100. Thus, the device ID (id) is shared in advance by the memory card 100 and the license issuing device 200. In addition, the memory card 100 has a device key Kd1 while the license issuing device 200 has a device key Kd2. The device keys Kd1 and Kd2 are retained by the respective devices and protected from being read externally. Desirably, they are protected with a tamper-resistant device of which analysis is substantially impossible. Assume that the device keys Kd1 and Kd2 are the same when the memory card 100 and the license issuing device 200 are both valid ones to each other.

First, in step ST601, the partner device verification means 120 of the memory card 100 produces encrypted device ID (Ei1), which is obtained by encrypting the device ID (id) of the memory card 100 with the device key Kd1. This encrypted device ID is represented by Ei1=F(Kd1, id) in FIG. 6.

In step ST611, the memory card verification means 210 of the license issuing device 200 produces encrypted device ID (Ei2), which is obtained by encrypting the device ID (id) of the memory card 100 with the device key Kd2. This encrypted device ID is represented by Ei2=F(Kd2, id) in FIG. 6.

It is then confirmed that the encrypted device IDs (Ei1, Ei2) held by the respective devices are the same in the following processing without involving any exchange via an external communication medium, to thereby verify that they are authorized devices.

In step ST602, the partner device verification means 120 of the memory card 100 generates a random number RI and transmits the random number to the memory card verification means 210 of the license issuing device 200.

In step ST603, the partner device verification means 120 of the memory card 100 encrypts the random number R1 with the encrypted device ID (Ei1) to generate an encrypted random number E1r1, which is represented by E1r1=E(Ei1, R1) in FIG. 6.

In step ST612, the memory card verification means 210 of the license issuing device 200 encrypts the received random number R1 with the encrypted device ID (Ei2) to generate an encrypted random number E2r1, which is represented by E2r1=E(Ei2, R1) in FIG. 6. The memory card verification means 210 of the license issuing device 200 then transmits the encrypted random number E2r1 to the partner device verification means 120 of the memory card 100.

In step ST604, the partner device verification means 120 of the memory card 100 compares the encrypted random number E1r1 generated in step ST603 with the encrypted random number E2r1 received in step ST612. If the two encrypted random numbers do not match with each other, the process proceeds to step ST606, where the partner device verification means 120 regards the license issuing device 200 as invalid (error occurs) and notifies the user of this fact. The process is then terminated. on the contrary, if the two encrypted random numbers match with each other, the partner device verification means 120 regards the license issuing device 200 as valid, and the process proceeds to step ST605.

In step ST613, the memory card verification means 210 of the license issuing device 200 generates a random number R2 and transmits the random number to the partner device verification means 120 of the memory card 100.

In step ST614, the memory card verification means 210 of the license issuing device 200 encrypts the random number R2 with the encrypted device ID (Ei2) to generate an encrypted random number E2r2, which is represented by E2r2=E(Ei2, R2) in FIG. 6.

In step ST605, the partner device verification means 120 of the memory card 100 encrypts the received random number R2 with the encrypted device ID (Ei1) to generate an encrypted random number E1r2, which is represented by E1r2=E(Ei1, R2) in FIG. 6. The partner device verification means 120 of the memory card 100 then transmits the encrypted random number E1r2 to the memory card verification means 210 of the license issuing device 200.

In step ST615, the memory card verification means 210 of the license issuing device 200 compares the encrypted random number E2r2 generated in step ST614 with the encrypted random number E1r2 received in step ST605. If the two encrypted random numbers do not match with each other, the process proceeds to step ST616, where the memory card verification means 210 of the license issuing device 200 regards the memory card 100 as invalid (error occurs) and notifies the user of this fact. The process is then terminated. On the contrary, if the two encrypted random numbers match with each other, the memory card verification means 210 of the license issuing device 200 regards the memory card 100 as valid.

As described above, mutual verification is performed between the memory card 100 and the license issuing device 200 to confirm that they are valid devices to each other.

After the procedure of mutual verification, the memory card verification means 210 outputs the encrypted device ID (Ei2) to the encryption means 260.

In the above description, the device keys Kd1 and Kd2 are used. Alternatively, the encrypted device IDs Ei1 and Ei2 may be obtained without using the device keys but by subjecting the device IDs to specific transformation F. In this case, the transformation F is made secret, and devices having a common transformation method are verified as valid ones to each other.

<Construction of Contents Reproducing Device 300>

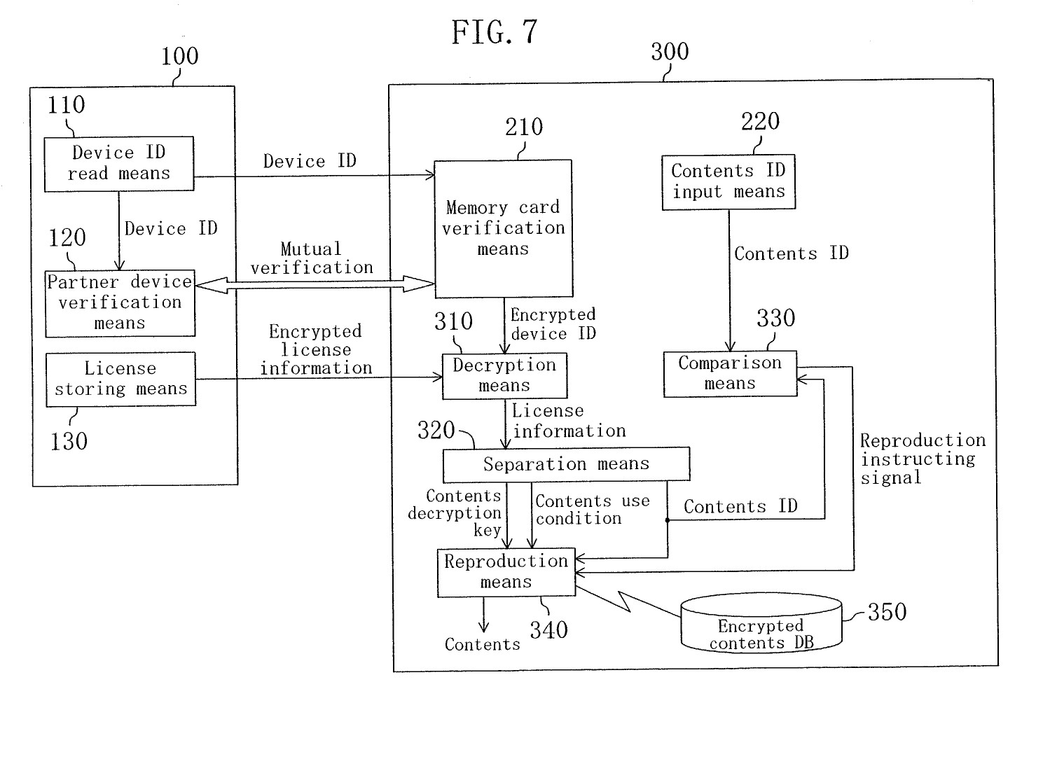

FIG. 7 is a block diagram showing specific constructions of the memory card 100 and the contents reproducing device 300 shown in FIG. 1. Hereinafter, the specific construction of the contents reproducing device 300 will be described with reference to FIG. 7.

The contents reproducing device 300 includes a memory card verification means 210, a contents ID input means 220, a decryption means 310, a separation means 320, a comparison means 330, a reproduction means 340, and an encrypted contents database 350.

The decryption means 310 reads the encrypted license information stored in the license storing means 130 of the memory card 100 and decrypts the read encrypted license information with the encrypted device ID received from the memory card verification means 210, to obtain license information.

The separation means 320 obtains the contents ID, the contents use condition, and the contents decryption key from the license information obtained by the decryption means 310.

The comparison means 330 compares the contents ID obtained by the separation means 320 with the contents ID obtained from the contents ID input means 220. If the two contents IDs match with each other, the comparison means 330 sends a reproduction instructing signal to the reproduction means 340.

The encrypted contents database 350 stores encrypted contents that are unusable in the state as they are.

In response to the reproduction instructing signal from the comparison means 330, the reproduction means 340 retrieves the encrypted contents corresponding to the contents ID obtained by the separation means 320 from the encrypted contents database 350. The reproduction means 340 then decrypts the retrieved encrypted contents with the contents decryption key obtained by the separation means 320, and reproduces the decrypted contents according to the contents use condition obtained by the separation means 320.

<Procedure of Reproduction of Contents>

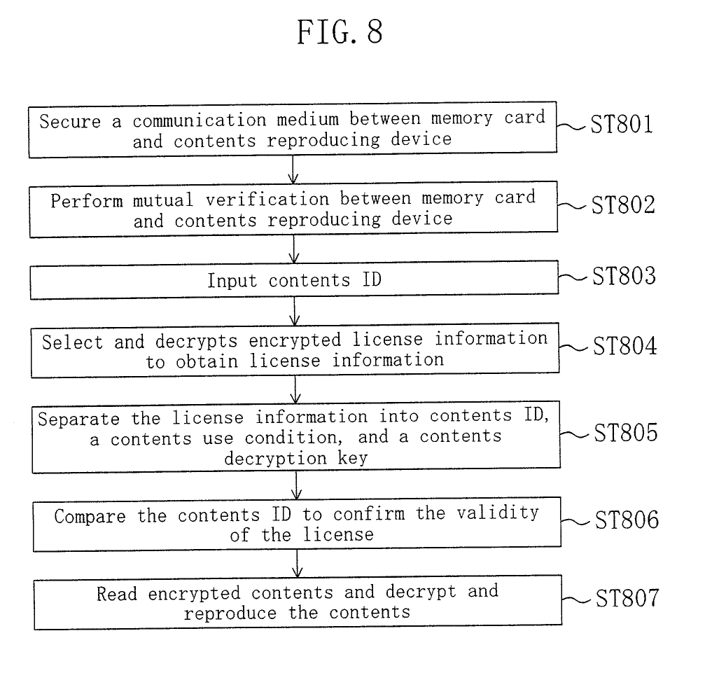

FIG. 8 is a flowchart showing a procedure of reproduction of contents by the contents reproducing device 300 shown in FIG. 7. Hereinafter, the procedure of reproduction of contents will be described with reference to FIG. 8 together with FIG. 7.

First, in step ST801, the user inserts the memory card 100 into an insertion slot of the contents reproducing device 300. In the memory card 100, encrypted license information for contents of which reproduction is desired is stored. By this insertion, the pin of the memory card 100 comes into electrical contact with a socket of the contents reproducing device 300, to thereby secure a communication medium for data transmission/reception between the memory card 100 and the contents reproducing device 300.

In step ST802, the memory card 100 and the contents reproducing device 300 mutually verify that they are valid devices to each other. This mutual verification is performed in a procedure similar to that shown in FIG. 6. After the mutual verification, the memory card verification means 210 of the contents reproducing device 300 encrypts the device ID of the memory card 100 to produce encrypted device ID.

In step ST803, the user inputs contents ID corresponding to contents of which reproduction is desired via the contents ID input means 220. In general, a plurality of units of encrypted license information are stored in the license storing means 130 of the memory card 100. As shown in FIG. 5, however, the license storing means 130 stores the contents title 51, the contents additional information 52, and the like in association with the encrypted license information 53. Therefore, it is possible to display a list of contents title and contents additional information stored in the license storing means 130 of the memory card 100, to enable the user to select a desired contents title. In this way, the con25 tents ID can be obtained using a database similar to that shown in FIG. 3.

In step ST804, the decryption means 310 reads the encrypted license information corresponding to the contents of which reproduction is desired by the user from the license storing means 130 of the memory card 100. In this embodiment, the encrypted license information to be decrypted can be easily specified from the contents title selected by the user in step ST803. The decryption means 310 then decrypts the read encrypted license information with the encrypted device ID produced by the memory card verification means 210 in step ST802, to obtain license information.

In step ST805, the separation means 320 separates the license information obtained by the decryption means 310 into the contents ID, the contents decryption key, and the con15 tents use condition.

In step ST806, the comparison means 330 compares the contents ID obtained via the contents ID input means 220 in step ST803 with the contents ID obtained by the separation means 320 in step ST805. As a result of the comparison, if the two contents IDs match with each other, it is regarded that the license information has been issued by a valid license issuing device. The comparison means 330 then sends the reproduction instructing signal to the reproduction means 340.

In step ST807, in response to the reproduction instructing signal from the comparison means 330, the reproduction means 340 retrieves the encrypted contents corresponding to the contents ID obtained by the separation means 320 from the encrypted contents database 350. The reproduction means 340 then decrypts the retrieved encrypted contents with the contents decryption key obtained by the separation means 320, and reproduces the decrypted contents according to the contents use condition obtained by the separation means 320. For example, when an expiry date is added as a contents use condition, the current date and the expiry date are compared prior to reproduction to determine whether or not reproduction should be performed.

Thus, the contents desired by the user are reproduced.

As described above, the contents reproducing device 300 in Embodiment 1, which is provided with the memory card verification means 210, the decryption means 310, and the reproduction means 340, can read license information separated from the contents from the memory card 100 that has been verified as valid, and reproduce the corresponding contents.

In this embodiment, the encrypted contents database 350 was formed in the contents reproducing device 300. Alternatively, the encrypted contents database may be provided externally at a remote place, for example, and connected via a communication line. In this case, the contents reproducing device 300 receives encrypted contents from an external encrypted contents database by specifying the contents using information such as contents ID, and reproduces the received contents. This construction of providing the encrypted contents database externally is advantageous for an application where the contents reproducing device is a portable terminal that fails to secure a large memory capacity.

When no contents use condition is included in the license information stored in the license storing means 130 of the memory card 100, no contents use condition is obtained by the separation means 320. In this case, the contents reproduction means 340 does not need to consider any contents use condition.

When no contents decryption key is included in the license information stored in the license storing means 130 of the memory card 100, a database associating the contents ID with the contents decryption key as shown in FIG. 5 should be prepared. With such a database, the contents decryption key can be retrieved using the contents ID obtained by the separation means 320.

When the encrypted license information read from the license storing means 130 of the memory card 100 is sufficiently reliable, the contents ID input means 220 and the comparison means 330 may be omitted.

The encryption means 260 of the license issuing device 200 shown in FIG. 2 and the decryption means 310 of the contents reproducing device 300 shown in FIG. 7 use the encrypted device ID from the memory card verification means 210 as the encryption/decryption key. Alternatively, the license issuing device 200 and the contents reproducing device 300 may previously store an externally non-readable secret key, and this key may be used as the encryption/decryption key. Further, in this case, asymmetric encryption such as RSA may be adopted as cryptographic algorithm for encryption/decryption, and the devices may store respective corresponding keys.

<Effects>

As described above, according to the contents providing system in Embodiment 1 of the present invention, the license issuing device 200 writes license information for contents in the memory card 100 as a portable independent hardware unit. The contents reproducing device 300 reproduces the contents according to the license information stored in the memory card 100. This enables the user, who carries the memory card 100 in which license information of desired contents has been written, to receive the contents using any of the contents reproducing devices 300 in various forms compatible with the license issuing device 200. In other words, the user can use the purchased contents without being restricted in the form of the contents reproducing device 300.

The license information is encrypted/decrypted with the encrypted device ID. In other words, the license information is encrypted/decrypted with device ID that can uniquely identify the individual memory card 100. This makes it possible to prevent fraud such as attempting to receive contents using a memory card in which encrypted license information has been illegally duplicated.

The license issuing device 200 writes only license information for contents in the memory card 100 carried by the user. Therefore, even when the contents desired by the user is large in capacity, the time required for issuance of the license information does not increase. Also, there is no need to worry about the memory capacity of the license storing means 130 of the memory card 100.

Moreover, since the data amount of the license information is small compared with the data amount of the contents, the user can obtain a large number of contents with one memory card 100.

The contents are distributed in the encrypted state. To reproduce the contents, the user must purchase license information for the contents. This enables the contents to be released freely by any means such as on a network, by broadcasting, and in a package. This also enables the user to obtain the contents easily. The user does not necessarily have to own the contents, but may purchase and carry only the license information to access the contents as required. As a result, when the user fails to secure a large-capacity data accumulating device for accumulating the contents, data may be downloaded on an as-needed basis during reproduction of the contents. This virtually provides an effect similar to that obtained when the user owns a contents server having an infinite capacity. On the contrary, when the user can secure a large-capacity data accumulating device, all of the contents that the user intends to reproduce may be downloaded in advance. When actually reproducing, the user may purchase license information for the contents. This makes it possible to promptly reproduce contents having a large capacity that otherwise takes time to be downloaded.

(Embodiment 2)

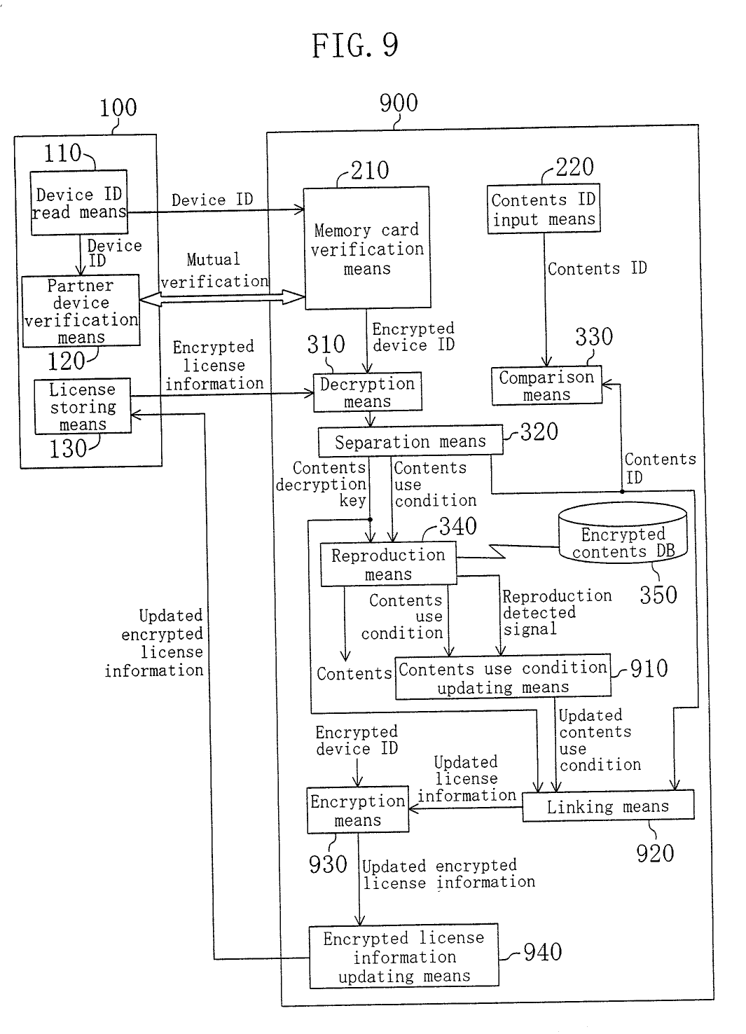

A contents providing system in Embodiment 2 of the present invention includes a contents reproducing device 900 shown in FIG. 9, in place of the contents reproducing device 300 shown in FIG. 7. The other construction is the same as that of the contents providing system in Embodiment 1.

<Construction of Contents Reproducing Device 900>

Referring to FIG. 9, the contents reproducing device 900 includes a memory card verification means 210, a contents ID input means 220, a decryption means 310, a separation means 320, a comparison means 330, a reproduction means 340, an encrypted contents database 350, a contents use condition updating means 910, a linking means 920, an encryption means 930, and an encrypted license information updating means 940.

In addition to the operation described in Embodiment 1, the reproduction means 340 generates and outputs a reproduction detected signal indicating completion of reproduction of contents, and also outputs the contents use condition.

Upon receipt of the reproduction detected signal from the reproduction means 340, the contents use condition updating means 910 reads the contents use condition from the reproduction means 340, and produces updated contents use condition by updating the contents use condition. This means is provided in consideration of the case that the contents use condition changes between before and after the reproduction of the contents (for example, the case that “the number of times of use of the contents” is set as a contents use condition). When the number of times of use has a limitation, the number of remaining times of use must be decremented by one every reproduction, and the decremented number of times of use must be entered as the new contents use condition.

The linking means 920 links the updated contents use condition from the contents use condition updating means 910 with the contents ID and the contents decryption key from the separation means 320, to produce updated license information.

The encryption means 930 encrypts the updated license information from the linking means 920 with the encrypted device ID from the memory card verification means 210, to produce updated encrypted license information.

The encrypted license information updating means 940 overwrites the encrypted license information stored in the license storing means 130 of the memory card 100 with the updated encrypted license information produced by the encryption means 930.

<Operation of Contents Reproducing Device 900>

The operation of the contents reproducing device 900 shown in FIG. 9 will be described.

The contents reproducing device 900 reproduces contents in substantially the same manner as that shown in steps ST801 through ST807 in FIG. 8. After completion of the reproduction of the contents or during the reproduction of the contents, the reproduction means 340 outputs the reproduction detected signal to the contents use condition updating means 910.

On receipt of the reproduction detected signal, the contents use condition updating means 910 reads the contents use condition from the reproduction means 340 and updates a portion of the contents use condition that should be changed after the reproduction. For example, when there exists a contents use condition that “the number of times of reproduction is limited to 3”, the number of times of reproduction is decremented by one to change to 2. The resultant contents use condition is output to the linking means 920 as the updated contents use condition.

The linking means 920 links the updated contents use condition with the contents ID and the contents decryption key, to produce updated license information.

The encryption means 930 encrypts the updated license information with the encrypted device ID.

The encrypted license information updating means 940 erases the encrypted license information stored in the license storing means 130 of the memory card 100 and writes the updated encrypted license information.

<Effect>

As described above, the contents reproducing device 900 in Embodiment 2, which is provided with the contents use condition updating means 910, the linking means 920, the encryption means 930, and the encrypted license information updating means 940, can update a contents use condition when the contents use condition changes after reproduction of the contents, and thus can retain the correct contents use condition.

(Embodiment 3)

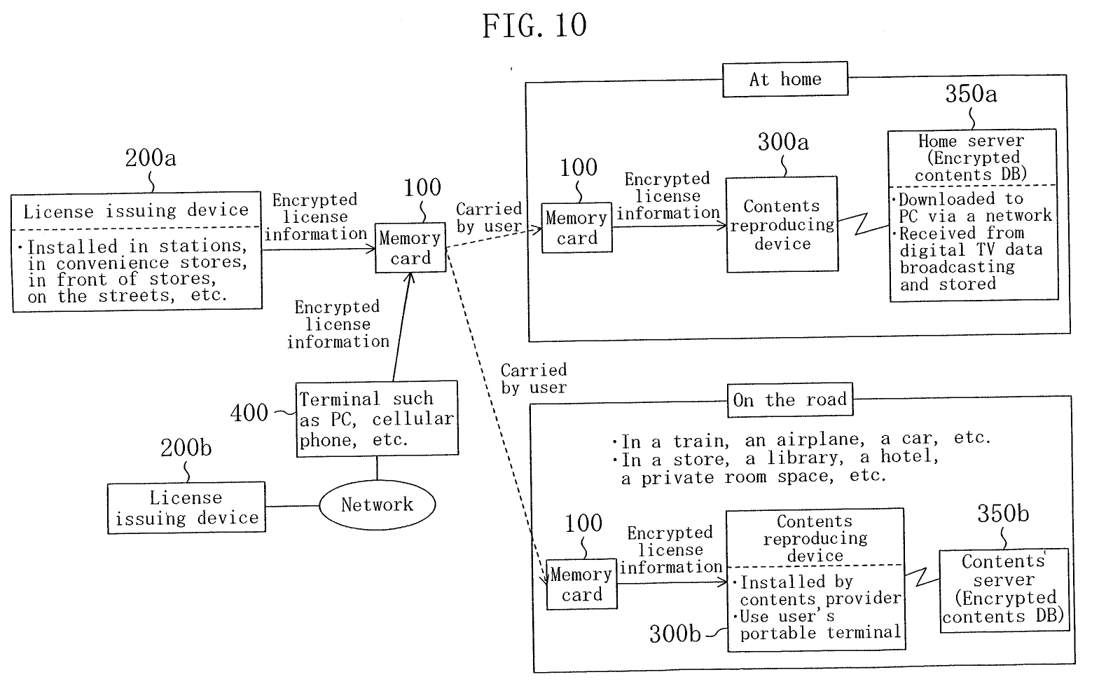

FIG. 10 shows an example of application of the contents providing system shown in FIG. 1. This example of application of the contents providing system will be described with reference to FIG. 10.

The license issuing device 200 may be installed in a station, in a convenience store, or in front of a store, for example (200a), or may be connected to a network to which a terminal 400 such as a personal computer and a cellular phone is accessible via a line or by wireless (200b). The user inserts the memory card 100 into the license issuing device 200a or a terminal 400, selects desired contents (a music number, a film, a game, an electronic book, or the like) under guidance, and pays a fee displayed. The license issuing device 200a, 200b encrypts license information for the contents selected by the user with device ID of the memory card 100 and writes the encrypted license information in the memory card 100. Upon completion of the writing, the user receives a receipt and pulls out the memory card 100. In this way, the user can receive encrypted license information for desired contents written in the memory card 100 at home or on the road. The user no more needs to carry a medium such as CD and MD in which desired contents have been stored, but may carry only the memory card 100 in which only license information has been written.

The contents have been encrypted to prevent use in the form as they are, and encrypted contents are available by various means such as on a network, by broadcasting, and in a package.

In a home server 350a installed in the home of the user, accumulated are encrypted contents downloaded to a personal computer via a network, encrypted contents obtained from digital TV data broadcasting, and the like. The user inserts the memory card in which encrypted license information of desired contents has been written to a contents reproducing device 300a in the home, and receives the contents.

On the road, also, a contents server 350b and a contents reproducing device 300b are installed (in a train, an airplane, a car, a store, a hotel, and the like). The contents reproducing device 300b may be installed by the provider of the contents, or the portable terminal carried by the user may be used as the contents reproducing device. The user inserts the memory card in which encrypted license information for desired contents has been written into the contents reproducing device 300b to receive the contents.

The contents provider can enjoy merits from providing an abundance of contents, such as the effect of attracting customers, exhibiting differentiation, and collecting fees. In addition, an advertisement may be displayed during reproduction of contents to earn advertisement income or introduce the provider's own stores. Moreover, a contents reproducing device enhanced in sound and image qualities may be installed to collect an extra charge (for example, an extra charge of 100 yen may be collected for high-definition images).

The user can listen to a favorite music number at home in a car, in a train, in a boat, in an airplane, and the like. The user no more needs to carry a medium such as CD and MD and a reproducing unit, but may carry only one memory card.

The user can also enjoy various types of contents such as listening to music, seeing a film, reading a book, and playing a game in a private room space that is currently in vogue. The provider of the private room space may permit the user to use the private room space free of charge when the user has a memory card in which license information has been written. If a license issuing device is installed around the private room space, the user can purchase license information on the spot when no license information has been written in the memory card.

Moreover, the user can access a magazine (contents) purchased before start of a trip to check the sights to visit on the road. By consulting in this way, the user no more needs to carry a magazine, a paper, an encyclopedia, and the like.

While the present invention has been described in a preferred embodiment, it will be apparent to those skilled in the art that the disclosed invention may be modified in numerous ways and may assume many embodiments other than that specifically set out and described above. Accordingly, it is intended-by the appended claims to cover all modifications of the invention which fall within the true spirit and scope of the invention.

What is claimed is:

1. A license issuing device for writing license information permitting use of contents in a portable license storing device, the license storing device having uniquely identifiable device ID and a function of verifying the validity of a partner device, the license issuing device comprising:
verification means for verifying the validity of a license storing device carried by a user;
means for producing license information permitting use of contents designated by the user when the license storing device carried by the user is verified as valid by the verification means; and
first encryption means for encrypting the license information produced by the means for producing license information with the device ID of the license storing device carried by the user and writing the encrypted license information in the license storing device carried by the user.

2. The license issuing device of claim 1, wherein the license information includes contents ID for identifying the contents designated by the user.

3. The license issuing device of claim 1, wherein the license information includes a contents use condition representing a restriction during use of the contents designated by the user.

4. The license issuing device of claim 1, wherein the license information includes a decryption key for decrypting the contents designated by the user.

5. The license issuing device of claim 1, wherein the verification means includes second encryption means for encrypting the device ID of the license storing device carried by the user with a device key possessed by the license storing device carried by the user, and
the first encryption means encrypts the license information with the device ID encrypted by the second encryption means and writes the encrypted license information in the license storing device carried by the user.

6. The license issuing device of claim 1, wherein the license issuing device is connected to the license storing device carried by the user via a network.

7. A contents reproducing device for decrypting encrypted contents and reproducing the decrypted contents,
the contents reproducing device decrypting contents based on license information stored in a portable license storing device and reproducing the decrypted contents, the license storing device having a uniquely identifiable device ID and a function of verifying the validity of a partner device, the license information having been encrypted with the device ID of the license storing device, the contents reproducing device comprising:
verification means for verifying the validity of a license storing device carried by a user;
decryption means for decrypting license information stored in the license storing device carried by the user with the device ID of the license storing device when the license storing device carried by the user is verified as valid by the verification means; and
reproduction means for decrypting encrypted contents corresponding to contents of which use is permitted in the license information obtained by the decryption means and reproducing the decrypted contents.

8. The contents reproducing device of claim 7, wherein the license information stored in the license storing device carried by the user includes a decryption key for decrypting the contents of which use is permitted in the license information, and
the reproduction means decrypts the encrypted contents corresponding to the contents of which use is permitted in the license information with the decryption key included in the license information obtained by the decryption means.

9. The contents reproducing device of claim 7, wherein the license information stored in the license storing device carried by the user includes contents ID for identifying the contents of which use is permitted in the license information, and
the reproduction means acquires the encrypted contents corresponding to the contents of which use is permitted in the license information using the contents ID included in the license information obtained by the decryption means.

10. The contents reproducing device of claim 7, further comprising accumulation means for accumulating encrypted contents, and
the reproduction means acquires the encrypted contents corresponding to the contents of which use is permitted in the license information obtained by the decryption means from the accumulation means.

11. The contents reproducing device of claim 7, wherein the reproduction means acquires the encrypted contents corresponding to the contents of which use is permitted in the license information obtained by the decryption means via a network.

12. The contents reproducing device of claim 7, wherein the license information stored in the license storing device carried by the user includes a contents use condition representing a restriction during use of the contents of which use is permitted in the license information, and
the reproduction means decrypts the encrypted contents corresponding to the contents of which use is permitted in the license information according to the contents use condition included in the license information obtained by the decryption means and reproduces the decrypted contents.

13. The contents reproducing device of claim 12, further comprising:
contents use condition updating means for updating a contents use condition included in the license information obtained by the decryption means after the reproduction of the contents by the reproduction means;
updated license information production means for producing updated license information including the contents use condition updated by the contents use condition updating means replacing the contents use condition included in the license information obtained by the decryption means;
encryption means for encrypting the updated license information produced by the updated license information production means with the device ID of the license storing device carried by the user; and
overwriting means for overwriting the license information stored in the license storing device carried by the user with the updated license information encrypted by the encryption means.

14. A contents reproducing device for decrypting encrypted contents and reproducing the decrypted contents,
the contents reproducing device decrypting contents based on license information stored in a portable license storing device and reproducing the decrypted contents, the license storing device having a uniquely identifiable device ID and a function of verifying the validity of a partner device, the license information having been encrypted with the device ID of the license storing device encrypted with a device key of the license storing device, the contents reproducing device comprising:
verification means for verifying the validity of a license storing device carried by a user, and, when the license storing device is verified valid, encrypting the device ID of the license storing device with the device key of the license storing device to produce the encrypted device ID;
decryption means for decrypting the license information stored in the license storing means carried by the user with the encrypted device ID produced by the verification means; and
reproduction means for decrypting encrypted contents corresponding to contents of which use is permitted in the license information obtained by the decryption means and reproducing the decrypted contents.

15. A license issuing method for writing license information permitting use of contents in a portable license storing device, the license storing device having uniquely identifiable device ID and a function of verifying the validity of a partner device, the method comprising the steps of:
verifying the validity of a license storing device carried by a user; and
when the license storing device carried by the user is verified as valid, encrypting license information permitting use of contents designated by the user with device ID of the license storing device carried by the user and writing the encrypted license information in the license storing device carried by the user.

16. A contents reproducing method for decrypting encrypted contents and reproducing the decrypted contents,
the contents reproducing method decrypting contents based on license information stored in a license storing device and reproducing the decrypted contents, the license storing device having a uniquely identifiable device ID and a function of verifying the validity of a partner device, the license information having been encrypted with the device ID of the license storing device, the method comprising the steps of:
verifying the validity of a license storing device carried by a user;
decrypting license information stored in the license storing device carried by the user with the device ID of the license storing device when the license storing device carried by the user is verified as valid in the step of verifying the validity; and
decrypting encrypted contents corresponding to contents of which use is permitted in the license information obtained in the step of decrypting license information, and reproducing the decrypted contents.

17. The contents reproducing method of claim 16, wherein in the step of decrypting and reproducing, encrypted contents corresponding to contents of which use is permitted in the license information obtained in the step of decrypting license information are acquired via a network.

18. The contents reproducing method of claim 16, wherein the license information stored in the license storing device carried by the user includes a contents use condition representing a restriction during use of contents of which use is permitted in the license information, and
in the step of decrypting and reproducing, encrypted contents corresponding to contents of which use is permitted in the license information are decrypted according to the contents use condition included in the license information obtained in the step of decrypting license information, and the decrypted contents are reproduced.

19. The contents reproducing method of claim 18, further comprising the steps of:
updating a contents use condition included in the license information obtained in the step of decrypting license information after the reproduction of the contents in the step of decrypting and reproducing;
encrypting updated license information including the contents use condition updated in the step of updating replacing the contents use condition included in the license information obtained in the step of decrypting license information with the device ID of the license storing device carried by the user; and
overwriting the license information stored in the license storing device carried by the user with the updated license information encrypted in the step of encrypting.
